(19) United States
(12) Patent Application Publication
(10) Pub. No.: US 2006/0140080 A1
(43) Pub. Date: Jun. 29, 2006

(54) MULTI-FUNCTION DIGITAL OPTICAL DISC PLAYER

(76) Inventors: Wen-Yi Yen, Taipei City (TW); Chih-Jen Hsiao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,577

(22) Filed: Feb. 24, 2005

(30) Foreign Application Priority Data
Dec. 24, 2004 (TW) 093140611

(51) Int. Cl. G11B 19/02

(52) U.S. Cl. 369/47.1; 369/97

(57) ABSTRACT

A multi-function digital video optical disc player includes a housing; an optical disc drive installed inside the housing for reading a first video data from an optical disc; a tape drive installed inside the housing for reading a DV tape to retrieve a second video data complying with a first data format; a video data format converter installed inside the housing for converting the second video data into a third video data complying with a second data format and for outputting the third video data; a decoder installed in the housing for decoding the first or the third video data to generate a fourth video data; and a display controller installed inside the housing for outputting display data to an external monitor according to the fourth video data.

### BACKGROUND OF INVENTION

1. Field of the Invention

The invention relates to a digital video optical disc player, and more particularly, to a digital video optical disc player which is also capable of playing tapes.

2. Description of the Prior Art

Playing (i.e. viewing) a digital camera tape utilizing traditional video optical disc players requires that a digital camera be connected to a digital video optical disc player through an Institute of Electrical and Electronic Engineers 1394 (IEEE 1394) port, other wire transmissions, or other wireless transmissions. After the digital camera and digital video optical disc player are connected, the data from the digital camera tape can be transferred to the digital video optical disc player. In this way, the digital video optical disc player can play the received data from the tape. Furthermore, if the digital video optical disc player supports the function of recording onto an optical disc, then the tape data can be recorded onto a digital video optical disc such as a multi-function digital disc or DVD.

However, such an operation is inconvenient. For instance, when playing or recording the tape's data, the digital camera must be connected to the digital video optical disc player during the entire operation of playing or recording the tape. Therefore, the digital camera cannot be utilized by other users or for other purposes during these operations.

Furthermore, in order to connect the prior art digital camera to the prior art digital video optical disc player, a cable (e.g. an IEEE 1394 cable) and a related interface (e.g. an IEEE 1394 interface) must be provided. Establishing the connection often causes additional complexity.

### SUMMARY OF INVENTION

The present invention provides a multi-function digital video optical disc player, which is also capable of reading digital camera tape data directly, in order to solve the above-mentioned problems.

By way of an example embodiment of the claimed invention, a multi-function digital video optical disc player is disclosed. The multi-function digital video optical disc player includes: a housing; an optical disc accessing device installed in the housing for reading a first video data from an optical disc; a first decoder installed in the housing for decoding the first video data to generate a second video data; a tape drive installed in the housing for reading a third video data from a digital camera tape; a second decoder installed in the housing for decoding the third video data to generate a fourth video data; and a display controller installed in the housing for outputting display data to an external display according to the second video data or the fourth video data; wherein the first video data complies with the first data format and the second video data complies with the second data format.

Furthermore, a multi-function optical disc player is disclosed. The multi-function video optical disc player includes: a housing; an optical disc accessing device installed in the housing for reading a first video data from an optical disc; a tape drive installed in the housing for reading a second video data from a digital camera tape, the second video data complying with the first data format; a video data format transformer installed in the housing for transforming the second video data into a third video data and outputting the third video data, the third video data complying with a second data format; a decoder installed in the housing for decoding the first video data or the third video data to generate a fourth video data; and a display controller installed in the housing for outputting the display data to an external display according to the fourth video data.

The present invention digital video optical disc player can read digital camera tape data with minimal hardware cost and can record digital camera tape data to an optical disc without the need for a digital camera. Therefore, the digital camera can be utilized for other purposes. Furthermore, a cable is no longer required. Therefore, the present invention multi-function video optical disc player provides a new function for the users, allowing them to utilize the digital camera freely.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a multi-function digital optical disc player according to the present invention.

FIG. 2 is a block diagram of the multi-function digital optical disc player shown in FIG. 1 of a first embodiment according to the present invention.

FIG. 3 is a block diagram of the multi-function digital optical disc player shown in FIG. 1 of a second embodiment according to the present invention.

### DETAILED DESCRIPTION

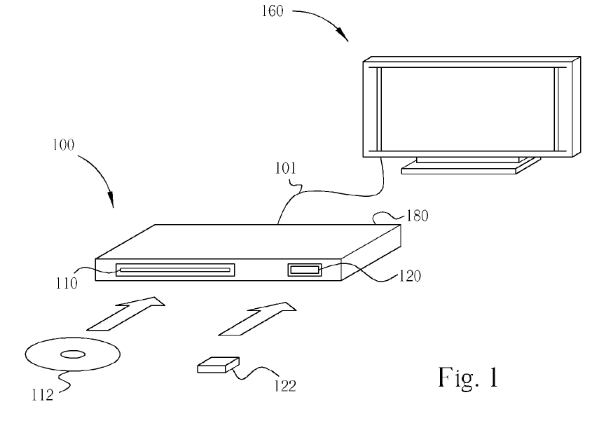

Please refer to FIG. 1, which is a diagram of a multi-function digital optical disc player 100 according to the present invention. In this embodiment, the multi-function digital optical disc player 100 is connected to an external display 160 through a cable 101, for example, an audiovisual cable (AV cable) or a composite cable. The multi-function digital optical disc player 100 includes a recordable optical disc accessing device 110 and a Mini-DV tape drive 120, wherein the recordable optical disc accessing device 110 and the Mini-DV tape drive 120 are both installed in the same housing 180. The recordable optical disc accessing device 110 can be utilized to read video data from an optical disc 112. Therefore, the multi-function digital optical disc player 100 can output display data, corresponding to the read video data, to an external display 160. The external display 160 can then display video corresponding to the video data. Additionally, the recordable optical disc accessing device 110 can be utilized to burn data (for example, a TV program) to the optical disc 112. The Mini-DV tape drive 120 is embedded in the multi-function digital video optical disc player 100 for reading video data from a DV tape 122. Therefore, the multi-function digital video optical disc player 100 can output display data, corresponding to the read video data, to the external display 160. The external display 160 can then display video, corresponding to the video data, or the read video data can be transferred to the recordable optical disc accessing device 110 to be burned.

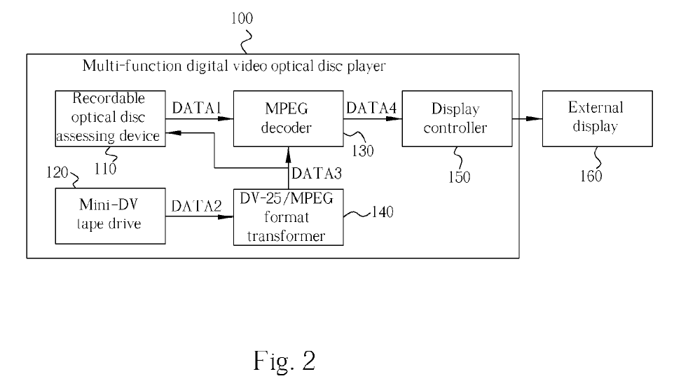

Please refer to FIG. 2 in conjunction with FIG. 1. FIG. 2 is a block diagram of the multi-function digital optical disc player 100 shown in FIG. 1 of a first embodiment according to the present invention. As shown in FIG. 2, the multi-function digital video optical disc player 100 includes a recordable optical disc accessing device 110, a Mini-DV tape drive 120, a Motion Picture Experts Group (MPEG) decoder 130 coupled to the recordable optical disc accessing device 110, a DV-25/MPEG format transformer 140 coupled to the Mini-DV tape drive 120 and the MPEG decoder 130, and a display controller 150 coupled to the MPEG decoder 130. Please note that the above-mentioned devices are all installed in the housing 180. The function and the operation of the multi-function digital video optical disc player 100 are illustrated as follows.

When the multi-function video optical disc player 100 has to play video data from the optical disc 112, the recordable optical disc accessing device 110 first reads video data DATA1, which complies with the MPEG data format, from the optical disc 112 and outputs the video data DATA1 to the MPEG decoder 130. Next, the MPEG decoder 130 decodes the video data DATA1 to generate another video data DATA4 and output the video data DATA4 to the display controller 150. Finally, the display controller 150 generates display data according to the video data DATA4 for the external display 160 such that the external display 160 can display read video data. Please note that the external display 160 can be a TV or other device capable of displaying corresponding images when receiving display data.

When the multi-function video optical disc player 100 plays a digital camera tape 122, the Mini-DV tape drive 120 reads video data DATA2, which complies with the DV-25 data format, from the digital camera tape 122 and outputs the video data DATA2 to the DV-25/MPEG format transformer 140. Please note that it is well known that the DV-25 data format is very similar to the MPEG data format. Therefore, the video data DATA2, complying with the DV-25 data format, can be easily transformed into video data DATA3, complying with the MPEG data format. Here, the DV-25/MPEG format transformer 140 transforms the video data DATA2, complying with the DV-25 data format, into the video data DATA3, complying with the MPEG data format, and outputs the video data DATA3 to the MPEG decoder 130. As mentioned above, the MPEG decoder 130 decodes the video data DATA3 to generate another video data DATA4 and outputs the video data DATA4 to the display controller 150. The display controller 150 generates display data for the external display 160 according to the video data DATA4. The external display 160 displays corresponding images according to the display data.

Additionally, in this embodiment, the multi-function digital video optical disc player 100 can directly burn the data from the digital camera tape 122 utilizing the optical disc 112 (for example, a CD-R/RW, a DVD-R/RW, or a DVD+R/RW optical disc) without a connected external digital camera. The related operation is illustrated as follows. First, the Mini-DV tape drive 120 reads the video data DATA2, complying with the DV-25 data format, from the digital camera tape 122 and outputs the video data DATA2 to the DV-25/MPEG format transformer 140. Next, the DV-25/MPEG format transformer 140 transforms the video data DATA2 into video data DATA3, complying with the MPEG data format. Since the video data DATA3 complies with the MPEG data format, the video data DATA3 can be burned to a normal video optical disc. Therefore, the DV-25/MPEG format transformer 140 outputs the video data DATA3 to the recordable optical disc accessing device 110. Finally, the recordable optical disc accessing device 110 can burn the video data DATA3 to the optical disc 112.

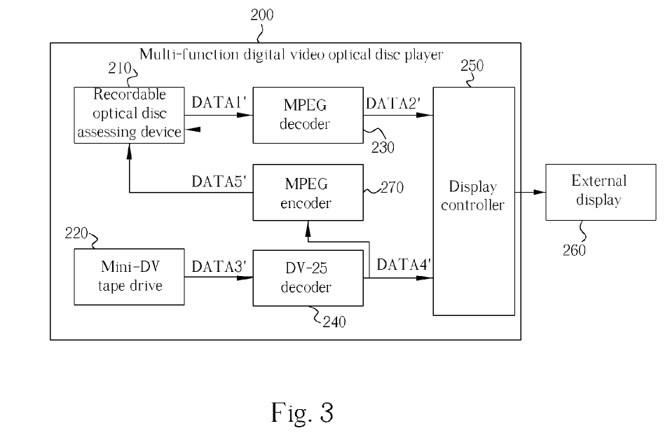

Please refer to FIG. 3 in conjunction with FIG. 1. FIG. 3 is a block diagram of the multi-function digital optical disc player 200 shown in FIG. 1 of a second embodiment according to the present invention. In this embodiment, the multi-function video optical disc player 200 includes a recordable optical disc accessing device 210, a Mini-DV tape drive 220, a MPEG decoder 230 coupled to the recordable optical disc accessing device 210, a DV-25 decoder 240 coupled to the Mini-DV tape drive 220, a display controller 250 coupled to the MPEG decoder 230 and the DV-25 decoder 240, and a MPEG encoder 270 coupled to the DV-25 decoder 240 and the recordable optical disc accessing device 210. Similar to the first embodiment, the above-mentioned devices are all installed in the same housing 180. The operations and functions of devices having the same name and number are identical to those in the first embodiment and thus, their descriptions are omitted here. The function and the operation of the multi-function digital video optical disc player 200 are illustrated as follows.

When the multi-function digital video optical disc player 200 plays the optical disc 112, the recordable optical disc accessing device 210 reads video data DATA1, complying with the MPEG data format, from the optical disc 112 and outputs the video data DATA1 to the MPEG decoder 230. Next, the MPEG decoder 230 decodes the video data DATA1 to generate another video data DATA2 and outputs the video data DATA2 to the display controller 250. Finally, the display controller 250 generates display data for the external display 260 according to the video data DATA2.

Additionally, when the multi-function digital video optical disc player 200 plays the digital camera tape 122, the Mini-DV tape drive 220 reads video data DATA3 complying with the DV-25 data format from the digital camera tape 122 and outputs the video data DATA3 to the DV-25 decoder 240. Please note that in the first embodiment, the video data DATA2, complying with the DV-25 data format, is transformed into video data complying with the MPEG data format. However, in this embodiment, the DV-25 decoder 240 is installed for direct decoding of the video data DATA3. Therefore, the DV-25 decoder decodes the video data DATA3 to generate video data DATA4 and outputs the video data DATA4 to the display controller 250. Finally, the display controller 250 generates display data to the external display 260 according to the video data DATA4. Similarly, the external display 260 can display corresponding images according to the display data.

Furthermore, in this embodiment, the multi-function digital optical disc player 200 can directly record the data from the digital camera tape 122 to the optical disc 122 without being connected to an external digital camera. First, the Mini-DV tape drive 220 reads video data DATA3, complying with the DV-25 data format, from the digital camera tape 122 and outputs the video data DATA3 to the DV-25 decoder 240. Second, the DV-25 decoder 240 decodes the video data DATA3 to generate video data DATA4 and outputs the video data DATA4 to the MPEG encoder 270. Next, the MPEG encoder 270 encodes the decoded video data DATA4 to generate video data DATA5, complying with the MPEG data format. Similarly, because the video data DATA5 complies with the MPEG data format, the MPEG encoder 270 outputs the video data DATA5 to the recordable optical disc accessing device 210. Finally, the recordable optical disc accessing device burns the video data DATA5 to the optical disc 212.

Please note that in the above disclosure, the DV-25 data format is only utilized as an example and is not a limitation. The present invention digital video optical disc player 100 can support additional data formats (for example, DV-50 and DV-100). A DV-50/MPEG or DV-100/MPEG format transformer can replace the DV-25/MPEG format transformer 140 in the first embodiment, or utilize a DV-50 or DV-100 decoder to replace the DV-25 decoder in the second embodiment, such that the present invention multi-function video digital optical disc player 100 and 200 can support the DV-50 or DV-100 data formats.

Please note that, as mentioned in the first embodiment, the DV-25/MPEG format transformer 140 can directly transform the video data complying with the DV-25 data format into video data complying with the MPEG video data. Furthermore, because the DV-25 data format is very similar to the MPEG data format, the present invention requires minimal hardware cost to implement the DV-25/MPEG format transformer 140.

Additionally, the present invention multi-function digital video optical disc player 100 and 200 can include a memory buffer for temporarily storing a tape's video data, while that data is burned to an optical disc. As known by those skilled in this field, the memory buffer can prevent an interrupt when the video data is being burned.

Additionally, if another function of recording data from the optical disc to the tape is required, the present invention digital video optical disc player 100 can further include an MPEG/DV-25 format transformer to transform video data from the optical disc 112 into video data complying with the DV-25 data format, so that the video data complying with the DV-25 data format can be recorded onto the tape 122 smoothly. Similarly, the present invention multi-function video optical disc player 200 can further include a DV-25 encoder. The decoded video data can be further encoded into video data complying with the DV-25 data format such that the video data complying with the DV-25 data format can be recorded onto the tape 122. As mentioned above, the further related operations are already well known, and thus omitted here.

In contrast to the prior art, the present invention digital video optical disc player can read data directly from a digital camera tape and record the data from the digital camera tape directly to an optical disc with minimal hardware cost. Therefore, the digital camera is no longer required to be continuously connected to the optical disc player and can be utilized for other purposes. Furthermore, the cable utilized for the connection is no longer required. Therefore, the present invention digital video optical disc player provides users with a new function, which is, the users can utilize the digital camera freely.

Those skilled in this field will readily observe that numerous modifications and alterations of the device and method may be made while retaining the original concept of the invention. Accordingly, the above disclosure should be construed as limited only by the metes and bounds of the appended claims.

What is claimed is:

1. A multi-function digital video optical disc player comprising:
a housing;
an optical disc accessing device installed in the housing for reading a first video data from an optical disc;
a first decoder installed in the housing for decoding the first video data to generate a second video data;
a tape drive installed in the housing for reading a third video data from a digital camera tape;
a second decoder installed in the housing for decoding the third video data to generate a fourth video data; and
a display controller installed in the housing for outputting display data to an external display, according to the second video data or the fourth video data;
wherein the first video data complies with the first data format, the second video data complies with the second data format.

2. The multi-function optical disc player of claim 1, wherein the optical disc accessing device is a recordable optical disc accessing device for recording data to a video optical disc.

3. The multi-function optical disc player of claim 2 further comprising:
an encoder for receiving the fourth video data and encoding the fourth video data to generate a fifth video data complying with the first data format.

4. The multi-function optical disc player of claim 3, wherein the first data format complies with an MPEG standard.

5. The multi-function optical disc player of claim 1, wherein the digital camera tape is a Mini-DV tape.

6. The multi-function optical disc player of claim 5, wherein the second data format complies with the DV-25 standard, the DV-50 standard, or the DV-100 standard.

7. A multi-function optical disc player comprising:
a housing;
an optical disc accessing device installed in the housing for reading a first video data from an optical disc;
a tape drive installed in the housing for reading a second video data from a digital camera tape, the second video data complying with the first data format;
a video data format transformer installed in the housing for transforming the second video data into a third video data and outputting the third video data, the third video data complying with the second data format;
a decoder installed in the housing for decoding the first video data or the third video data to generate a fourth video data; and
a display controller installed in the housing for outputting display data to an external display according to the fourth video data.

8. The multi-function optical disc player of claim 7, wherein the optical disc accessing device is a recordable optical disc accessing device for recording a video optical disc.

9. The multi-function optical disc player of claim 8, wherein the recordable optical disc accessing device is capable of recording the third video data to the video optical disc.

10. The multi-function optical disc player of claim 7, wherein the first data format complies with an MPEG standard.

11. The multi-function optical disc player of claim 7, wherein the digital camera tape is a Mini-DV tape.

12. The multi-function optical disc player of claim 11, wherein the second data format complies with the DV-25 standard, the DV-50 standard, or the DV-100 standard.
